(19) United States
(12) Patent Application Publication
(10) Pub. No.: US 2002/0059104 A1
(43) Pub. Date: May 16, 2002

(54) Electronic shop sales system and electronic shop sales method

(75) Inventor: Takafumi Fukushima, Shizuoka-ken (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/014,092

(22) Filed: Nov. 13, 2001

(30) Foreign Application Priority Data
Nov. 15, 2000 (JP) 2000-348117

(51) Int. Cl. G06G 1/14

(52) U.S. Cl. 705/22; 705/28

(57) ABSTRACT

An electronic shop sales system having an article storage device and an electronic shop interconnected through a network communication line for selling an article to a user terminal connected to the network communication line from the electronic shop, wherein, upon receipt of an order of an article from the user terminal, a storage condition for the article is read from the article database, an environment controller of the article storage device is operated based on the storage condition to adjust the storage environment in an article container, the ordered article is stored in the article container, and the article is delivered to the user by way of the article storage device.

### CROSS-REFERENCE TO RELATED APPLICATIONS

This application is based upon and claims the benefit of priority from the prior Japanese Patent Application No. 2000-348117, filed Nov. 15, 2000, the entire contents of which are incorporated herein by reference.

### BACKGROUND OF THE INVENTION

1. Field of the Invention

The present invention relates to an electronic shop sales system and electronic shop sales method for selling an article to user terminals connected to a network communication line from an electronic shop connected to an article storage apparatus through the network communication line.

2. Description of the Related Art

Conventionally, for selling articles through mail-order sales, a known method utilizes a telephone, facsimile, postal service, personal computer communications and so on for receiving orders. The mail-order sales have been widespread because of the development as well as an increase in types of communication means and paths that allow customers to place an order anywhere at any time. An article ordered through mail-order sales is delivered by a courier and received directly at home or through a manager. In addition, a condominium or the like where many single households exist is provided with a courier post dedicated to delivered articles, so that a recipient can receive an ordered article once stored the courier post.

Jpn. Pat. Appln. KOKAI Publication No. 2000-99567 is known as a system that utilizes a storage device, in place of the courier post, which can be locked and unlocked by entering a secret identification number, and has a cooling capability for efficiently placing orders for articles and delivering ordered articles. This system transmits data on articles accepted by a variety of electronic shops to a single courier which acts transactions involved in distribution for all the electronic shops. The overall system is implemented by a single article order/delivery device.

Such use of the article order/delivery device results in an increased number of mail-order channels, and provides the ability to accept orders for articles anywhere at any time and to relatively safely store articles by the storage device. However, considering in users' place, even if an article is delivered and stored in the storage device, the article may be kept stored in the storage device for a long term if the recipient is too busy to immediately go pick up the article. In this event, this system is problematic in that the user is always anxious about whether the article is susceptible to deterioration, when the article has been delivered, which is unknown because no communication is made even if the article is delivered and stored in the storage device, whether the stored article is stolen, and the like. In addition, there is a problem on the delivery side that they cannot confirm whether their articles have been passed to customers without fail.

### BRIEF SUMMARY OF THE INVENTION

To solve the above problems, it is an object of the present invention to provide an electronic shop sales system and an electronic shop sales method which are capable of appropriately storing an article accepted by an electronic shop from a user's terminal in an article storage device under a storage condition suitable for the article.

In one aspect of the present invention, an electronic shop sales system includes an electronic shop connected to a network communication line, a user terminal connected to the network communication line, and an article storage device connected to the network communication line, wherein the electronic shop comprises:

an article database configured to manage article information and storage conditions;

a sales system configured to present articles managed by the article database to the user terminal through the network communication line for accepting an order of an article sold by the electronic shop from a user, and

a distribution system configured to perform a transaction required to deliver an article accepted through the sales system based on destination information,

the article storage device comprises

an article container having a door which is locked and unlocked; and

environment control section configured to control a storage environment in the article container, and

the electronic shop sales system is configured to be responsive to an order of an article received from the user terminal, for reading a storage condition for the article from the article database, operating the environment control section of the article storage device based on the storage condition to adjust the storage environment in the article container, storing the ordered article in the article container, and subsequently delivering the article to the user.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 is a block diagram illustrating the general configuration of an electronic shop sales system according to a first embodiment of the present invention;

FIG. 2 is a diagram showing an example of encoding a two-dimensional code from data in an article database and data in a customer database to print the two-dimensional code on a label in the embodiment of FIG. 1;

FIG. 3 shows contents of an article information code printed on a label in the first embodiment;

FIG. 4 is a perspective view illustrating an outer appearance of an article storage device in the first embodiment;

FIG. 5 is a block diagram illustrating the specific configuration of the article storage device in the first embodiment;

FIG. 6 is a flow diagram illustrating an operational procedure of the article storage device in the first embodiment;

FIG. 7 is a flow diagram illustrating communications among an electronic shop, an article storage device and a user terminal in a second embodiment of the present invention;

FIG. 8 is a flow diagram illustrating communications among the electronic shop, article storage device and user terminal in a third embodiment of the present invention;

FIG. 9 is a flow diagram illustrating communications among the electronic shop, article storage device and user terminal in a fourth embodiment of the present invention;

FIG. 10 is a flow diagram illustrating communications among the electronic shop, article storage device and user terminal in a fifth embodiment of the present invention;

FIG. 11 is a flow diagram illustrating communications among the electronic shop, article storage device and user terminal in a sixth embodiment of the present invention;

FIG. 12 is a flow diagram illustrating in detail a confirmation notice examination in the sixth embodiment;

FIG. 13 is a flow diagram illustrating communications among the electronic shop, article storage device and user terminal in a seventh embodiment of the present invention;

FIG. 14 is a flow diagram illustrating communications among the electronic shop, article storage device and user terminal in an eighth embodiment of the present invention;

FIG. 15 is a flow diagram illustrating communications among the electronic shop, article storage device and user terminal in a ninth embodiment of the present invention;

FIG. 16 is a block diagram illustrating the general configuration of an electronic shop sales system according to a tenth embodiment of the present invention;

FIG. 17 is a flow diagram illustrating communications among the electronic shop, article storage device and user terminal in the tenth embodiment of the present invention;

FIG. 18 is a flow diagram illustrating communications among the electronic shop, article storage device and user terminal in an eleventh embodiment of the present invention;

FIG. 19 is a block diagram illustrating the general configuration of an electronic shop sales system according to a twelfth embodiment of the present invention;

FIG. 20 is a flow chart illustrating the operation of the article storage device in the twelfth embodiment;

FIG. 21 is a block diagram illustrating the general configuration of an electronic shop sales system according to a thirteenth embodiment of the present invention; and

FIG. 22 is a flow chart illustrating the operation of the article storage device in the thirteenth embodiment.

### DETAILED DESCRIPTION OF THE INVENTION

In the following, embodiments of the present invention will be described with reference to the accompanying drawings.

(First Embodiment)

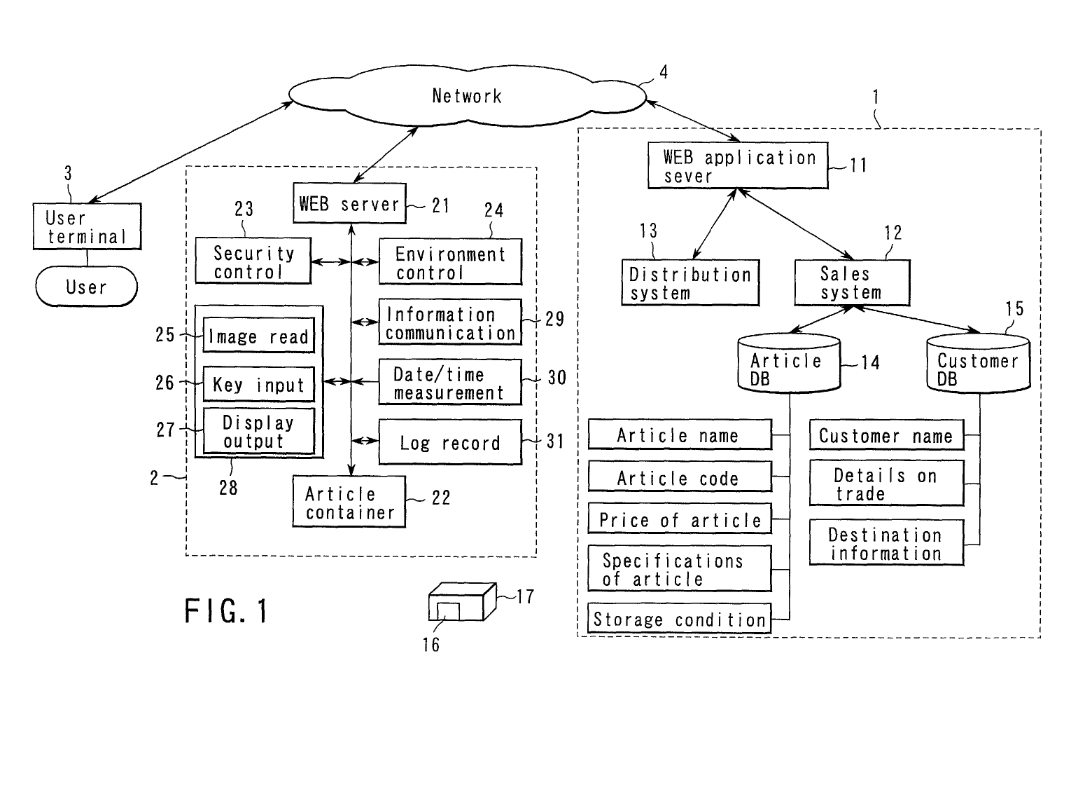

FIG. 1 is a block diagram illustrating the general configuration of an electronic shop sales system, wherein an electronic shop 1, an article storage device 2 and a user terminal 3 are interconnected through a communication line 4. The electronic shop 1 comprises a WEB application server 11 for governing an interface with the network communication line 4, such that the server 11 distributes data to a sales system 12 and a distribution system 13 depending on processing required by the user. The user terminal 3 may be an information terminal such as a personal computer, PAD and the like, a portable telephone, a facsimile, and the like.

The sales system 12 has an article database 14 and a customer database 15, and relies on the article database 14 to manage articles displayed in the electronic shop, more specifically, manage for each article an article name, an article code, a price of the article, specifications of the article, a storage condition for the article provided by the article storage device 2, and the like, and relies on the customer database 15 to manage for each customer the customer name, details on a trade, destination information, and the like.

The distribution system 13 is a management system for delivering an article traded by the sales system 12 to the user, and comprises a printing means capable of converting the article information and storage condition managed by the article database 14, and the customer name, details on a trade, destination information and the like managed by the customer database 15 into a two-dimensional machine code and printing the machine code on a label 16. For example, the label 16, such a slip of paper or a strip of cloth printed by the printing means, is attached on a delivery box for an article 17 to be delivered.

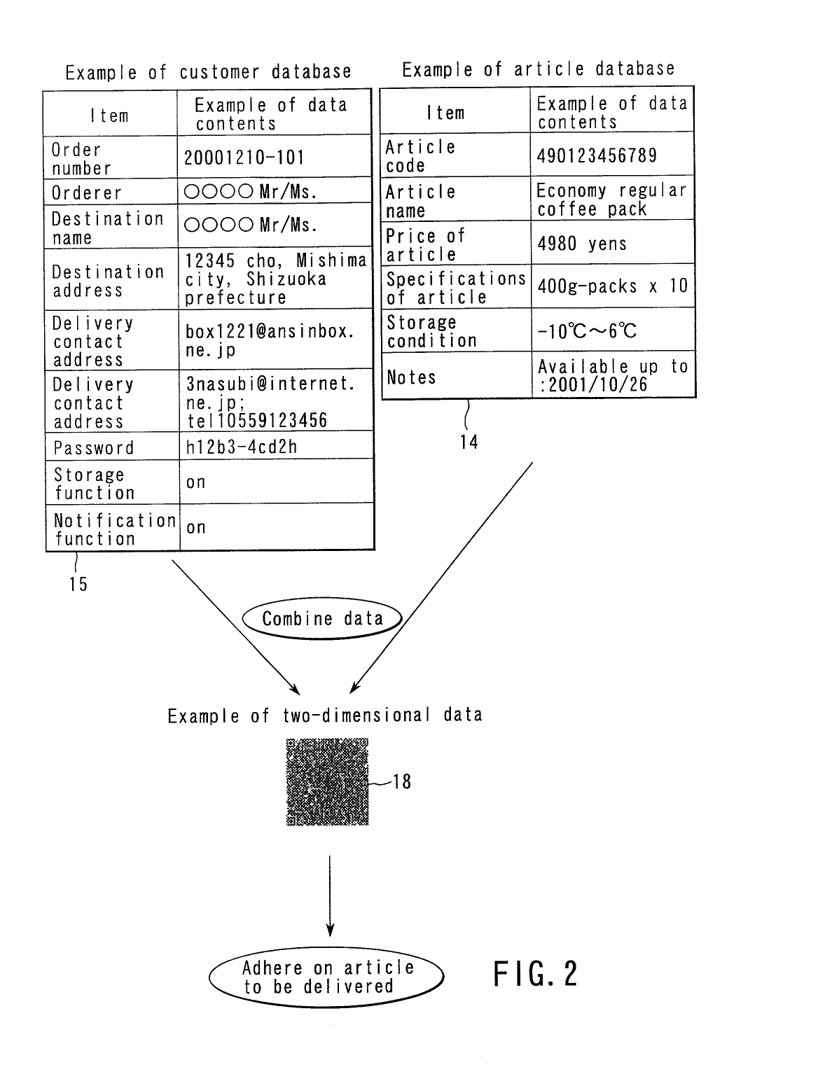

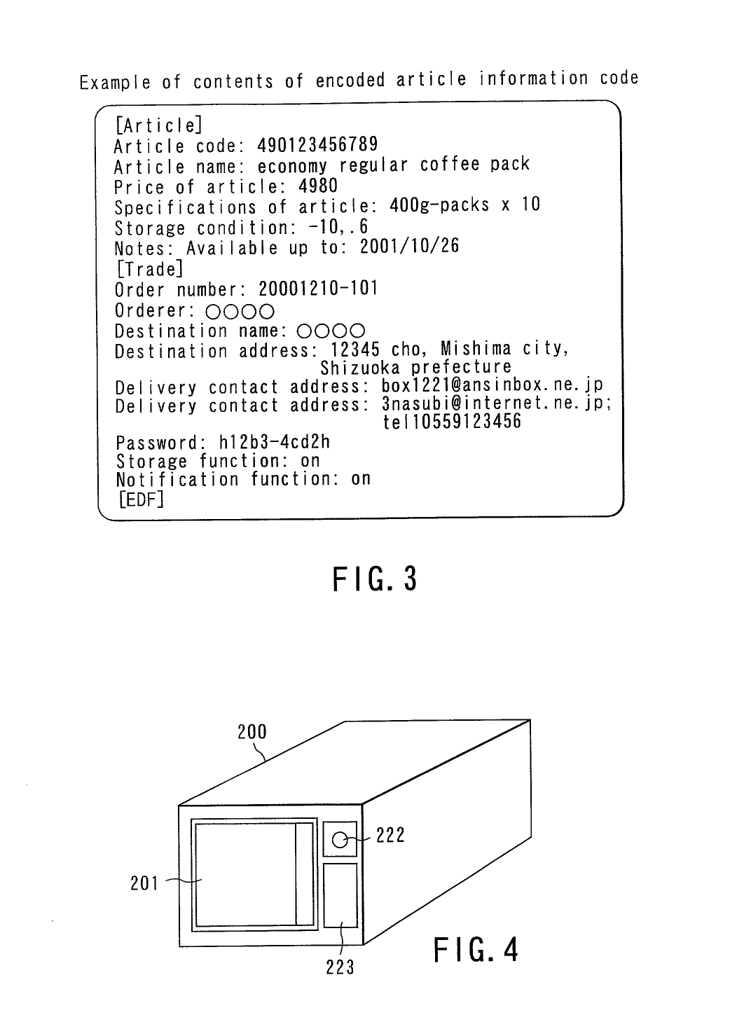

For example, as illustrated in FIG. 2, the printing means combines data such as the article name, article code, price of the article, specifications of the article, storage condition and so on managed by the article database 14, and the order number, orderer, recipient's name, destination address, delivery box, contact address, password, storage capability, notification capability, and the like managed by the customer database 15 to encode them into a two-dimensional code 18 in matrix which is printed on the label 16 as an article information code. Specifically, the article information code printed on the label 16 has contents, for example, as shown in FIG. 3. Alternatively, the two-dimensional code may be in the form of stack.

The article storage device 2 is installed, for example, near the user, and is provided with a WEB server 21 for governing an interface with the network communication line 4. Under the management of the WEB server 21, the article storage device 2 has an article container 22; a security control function 23 for providing control for respective components and programs associated with the security, such as locking and unlocking of the door of the article container 22; an environment control function 24 for providing control for respective components and programs associated with the environment, including at least temperature or humidity, in the article container 22; image reading means 25; a key input unit 26; and display output means 27. The article storage device 2 further has an input/output function 28 for providing functions and programs for interfacing with an operator; an information communication function 29 for communicating information to an external network using an electronic mail or data communications; a date/time measuring function 30 for managing a calendar to retrieve time data or date data as required, and for calculating the date or time; and a log recording function 31 for recording operations on the system.

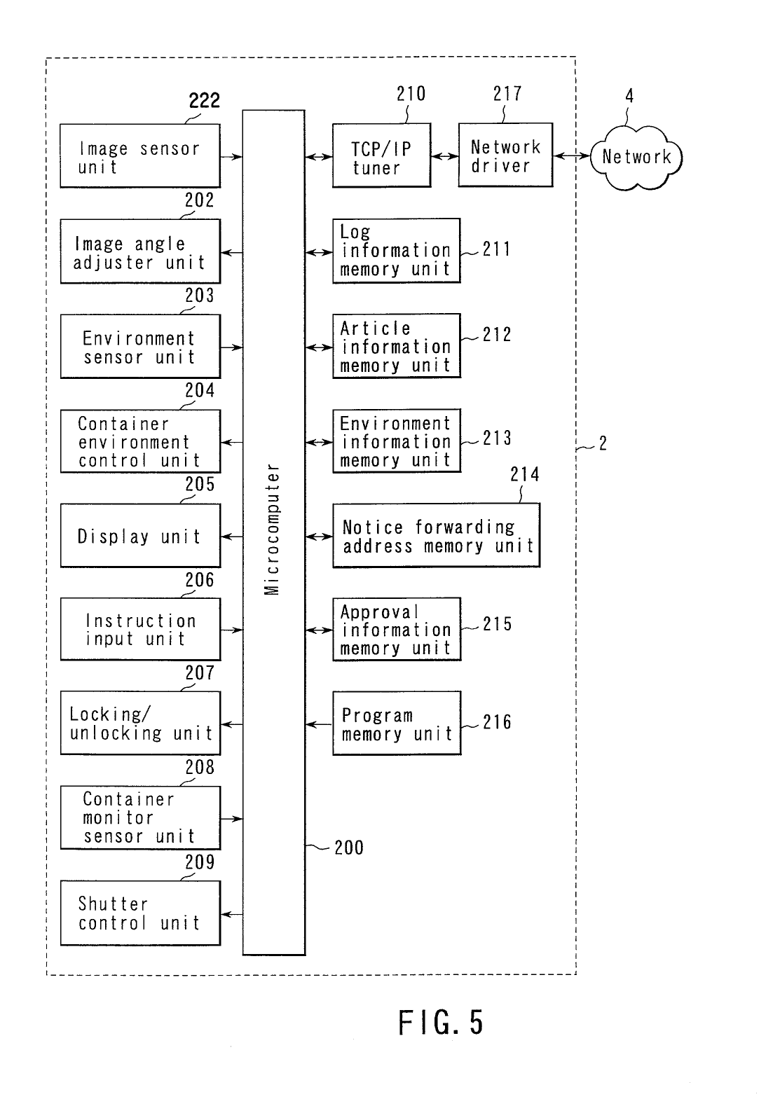

Specifically, as illustrated in FIG. 5, the article storage device 2 comprises a microcomputer 200. An image sensor unit 222, an image angle adjuster unit 202, an environment sensor unit 203, a container environment control unit 204, a display unit 205, an instruction input unit 206, a locking/unlocking unit 207, a container monitor sensor unit 208; a shutter control unit 209; a TCP/IP tuner 210; a log information memory unit 211; an article information memory unit 212; an environment information memory unit 213; a notice forwarding address memory unit 214; an approval information memory unit 215; and a program memory unit 216 are connected to the microcomputer 200 which programmably controls these components. The TCP/IP tuner 210 is connected to a net driver 217 which in turn is connected to the network communication line 4.

Then, as illustrated in FIG. 4, the article storage device 2 comprises a manipulation unit 223, on the front face of a housing 220, including an open/close door 201; an image sensor 222; the instruction input unit 206 and the display unit 205. The open/close door 201 is opened to store a delivered article in the article container inside the article storage device 2.

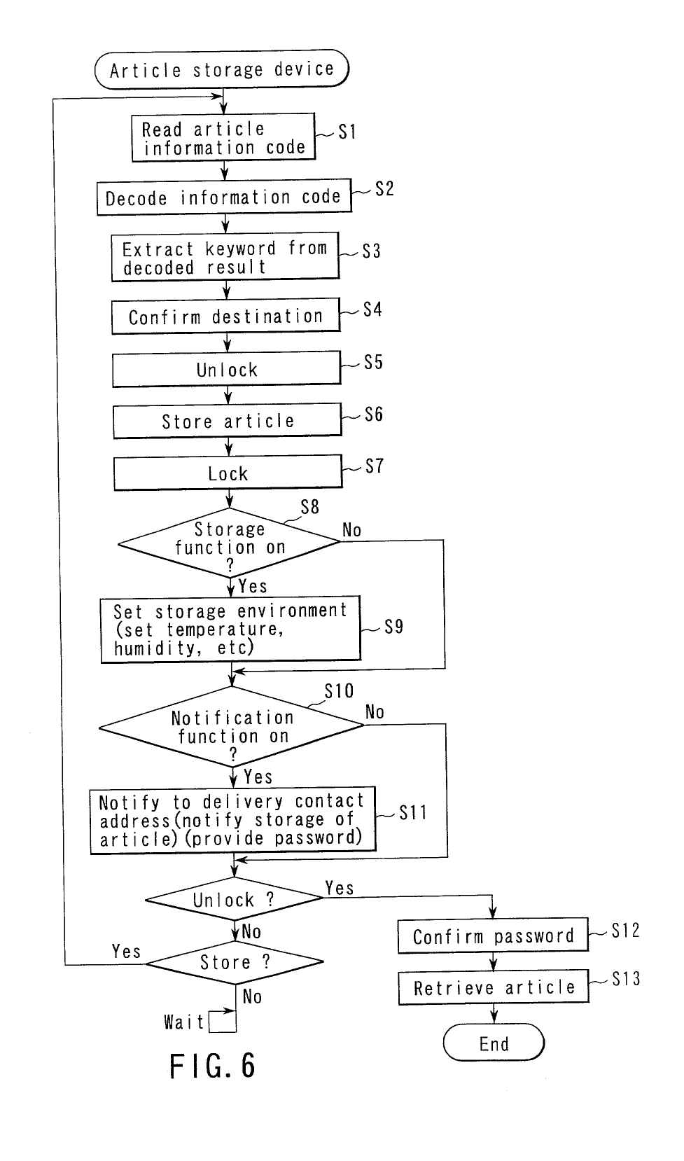

The article storage device 2 operates according to a procedure illustrated in FIG. 6. Specifically, the image sensor unit 222 reads an article information code from the label 16 at S1. The read article information code is decoded at S2, and a keyword is extracted from the decoded result at S3. Subsequently, the destination is confirmed at S4, the article storage device 2 is unlocked at S5, an article is stored in the article container 22 at S6, and then the door 201 of the article container 22 is locked at S7.

Then, it is determined at S8 whether or not a storage function in the code information is on. If so, the environment control function 24 sets a storage environment at S9. Specifically, the environment control function 24 sets the environment at least temperature or humidity in accordance with a storage condition set in the code information to accordingly operate the container environment control unit 204 and environment sensor unit 203.

Subsequently, it is determined at S10 whether or not a notice function in the code information is on. If so, the information communication function 29 notifies at S11 through an electronic mail to the delivery contact address, for example, a terminal of the user who ordered the article, that the article has been stored, and also provides a password.

In this state, the article storage device 2 is waiting for the user to unlock the door of the article container 22. Then, as the user unlock the door, the article storage device 2 confirms the password at S12, and subsequently the user retrieves the article from the article container 22 at S13, followed by the termination of a sequence of operations.

In the configuration as described, the user receives the presentation of articles by accessing the electronic shop 1 from the user terminal 3 through the network communication line 4, and orders a necessary article. In response, the electronic shop 1 reads the article name, article code, price, specifications and storage condition of the ordered article from the article database 14, and reads the order number, orderer (customer's name), recipient's name, destination address, delivery box, delivery contact address, password, storage function, and notice function from the customer database 15. The distribution system 13 combines these data for conversion into a two-dimensional code which is printed on a label as an article information code. A distribution department packages the ordered article in a box, and attaches the label on the box.

A person in charge of delivery takes the article 17 to a site at which the article storage device 2 is installed, and has the image sensor 222 read the article information code from the label 16. The article storage device 2 extracts a keyword from the read article information code, confirms the destination, and unlocks the door 201. Then, the person in charge of delivery places the article 17 into the article container 22. As the article has been stored, the door 201 is automatically locked.

In this event, if a storage function is set on in the article information code, the environment including at least temperature or humidity appropriate for the article are set based on the storage condition, so that the environment sensor unit 203 and container environment control unit 204 control the article container 22 to hold the environment including at least temperature or humidity at the set values. Also, if the notice function is set on in the article information code, the user terminal 3 is notified through an electronic mail that the ordered article has been stored in the article storage device 2, and is also provided with a password.

Therefore, the user is informed that the article has been delivered by confirming the electronic mail sent to the user terminal 3, and confirms the password. Then, the user goes to the site at which the article storage device 2 is installed, enters the password from the instruction input unit 206 to unlock the door 201, and retrieves the article from the article container 22.

In this way, the article accepted by the electronic shop 1 from the user terminal 3 can be stored under a storage condition suitable for the article by the article storage device 2, i.e., at the appropriate environment including at least temperature or humidity. This can prevent the article from deteriorating. Moreover, the container environment control unit 204 of the article storage device 2 starts to operate after the article is stored in the article container 22, so that the container environment control unit 204 of the article storage device 2 need not be operated at all times, thereby making it possible to save the electric power.

(Second Embodiment)

A second embodiment is identical to the foregoing first embodiment in the general configuration. The second embodiment employs an alternative article storage device 2 which previously adjusts a storage condition in the article container 22 to an environment appropriate for an article 17 before a scheduled time at which the article 17 is delivered.

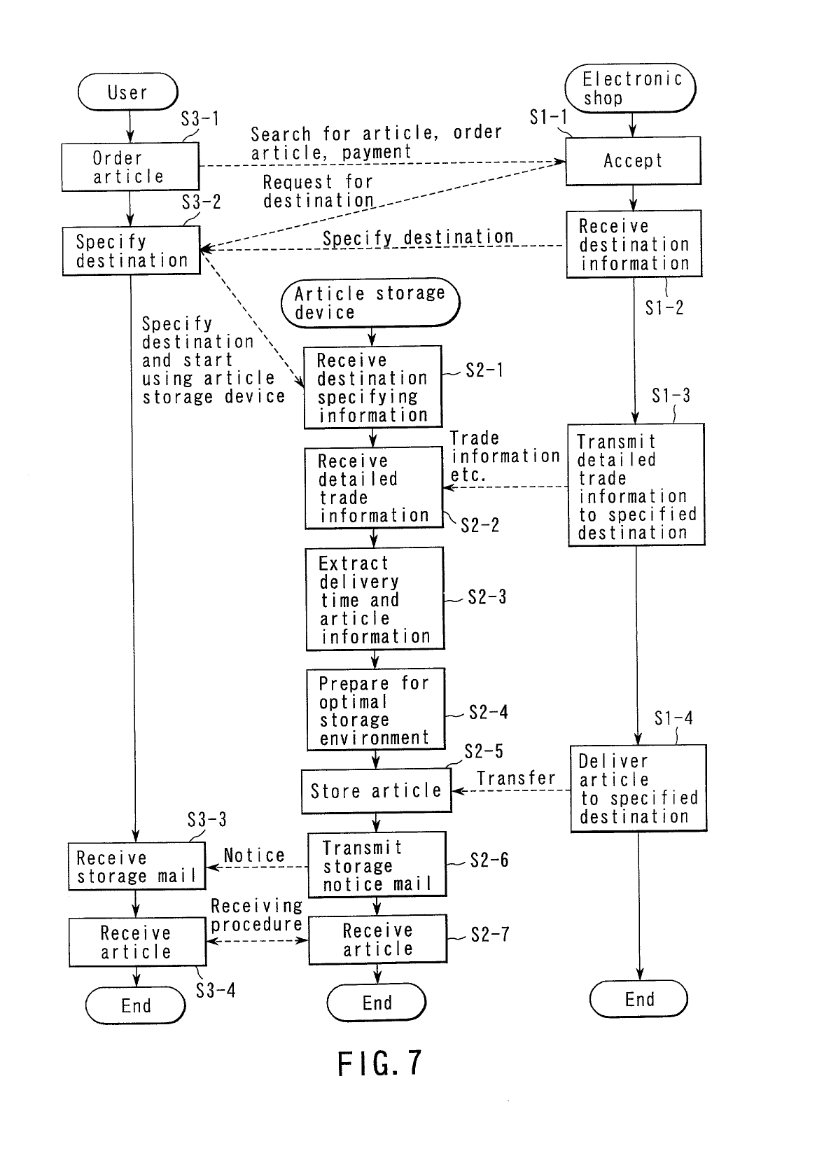

FIG. 7 is a flow chart illustrating communications among the electronic shop 1, article storage device 2 and user terminal 3, which are made through the network communication line 4. Specifically, first, the user terminal 3 orders an article at S3-1. More specifically, the user terminal 3 sequentially proceeds with a search of articles presented by the electronic shop 1, ordering of an article, and payment. In response, the electronic shop 1 performs an acceptance transaction, and asks the user terminal 3 for the destination at S1-1.

At S3-2, the user terminal 3 specifies the destination which is transmitted to the electronic shop 1 as well as to the article storage device 2. The user terminal 3 also transmits an instruction to the article storage device 2 to start using it. The electronic shop 1 receives the destination as destination information at S1-2, and reads necessary information such as article information, storage condition, delivery time and so on from the article database 14 and customer database 15 at S1-3, and transmits the read information to the article storage device 2 at the specified destination as detailed trade information.

The article storage device 2 receives the detailed trade information from the electronic shop 1 at S2-2, extracts the delivery time and article information from the detailed trade information at S2-3, and prepares for an optimal storage environment for the article container 22 at S2-4. Specifically, the article storage device 2 controls the environment sensor 203 and container environment control unit 204, in anticipation of the delivery time, to provide an optimal environment condition, including at least temperature or humidity, in the article container 22 at the delivery time.

On the other hand, the electronic shop 1 delivers the ordered article to the article storage device 2 at the specified destination at S1-4. In response, the article storage device 2 permits the article to be stored therein and confirms that the article is stored in the article container 22 at S2-5. Then, as the article has been stored, the article storage device 2 transmits a delivery notice, i.e., an electronic mail for notifying the storage to the user terminal 3 at S2-6.

Upon receipt of the storage notice mail from the article storage device 2 at the user terminal 3 at S3-3, the user knows that the ordered article has been delivered to the article storage device 2, and goes to the article storage device 2 for receiving the article at S3-4. At S2-7, the user receives the article at the article storage device 2. Then, as the article is received by the user, the article container 22 terminates the storage environment control.

In the foregoing manner, in anticipation of the article delivery time, the environment within the article container 22 is controlled such that the environment condition, including at least temperature or humidity, therein is optimal by the delivery time, so that the article container 22 provides an optimal environment for a delivered article at the time the article is delivered, thereby making it possible to store the article under the optimal condition and prevent the article from deteriorating without fail. Moreover, since the storage environment control for the article container 22 is terminated at the time the article is received, the electric power can be saved.

(Third Embodiment)

A third embodiment is also identical to the aforementioned first embodiment in the general configuration. The third embodiment employs an alternate article storage device 2 which reads a two-dimensional code from a label 16 attached on an article 17 by the image sensor 222 to unlock the door 201 of the article container 22.

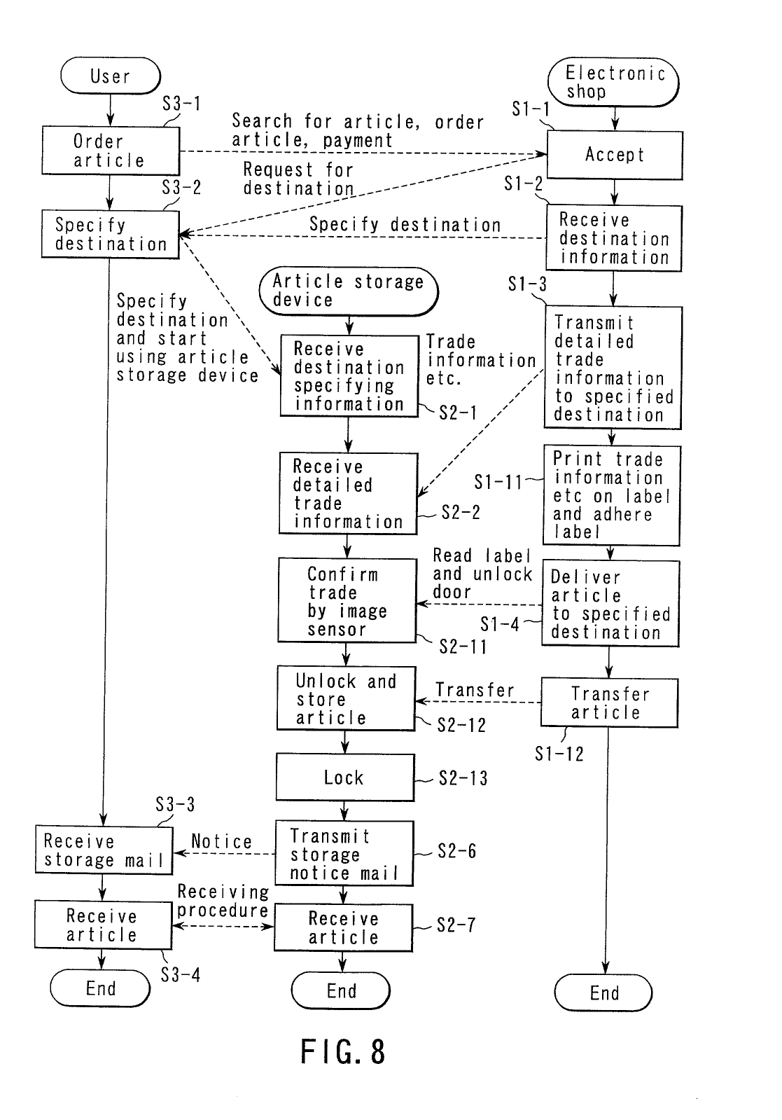

FIG. 8 is a flow diagram illustrating communications among the electronic shop 1, article storage device 2, and user terminal 3. It should be noted that steps identical to those in FIG. 7 are designated the same reference numerals and detailed description thereon is omitted.

As the electronic shop 1 transmits necessary information such as article information, storage condition and the like to the article storage device 2 at a specified destination as detailed trade information at S1-3, the detailed trade information is then converted into a two-dimensional code which is printed on a label which is then attached on an article box at S1-11. Next, at S1-4, the article is delivered to the article storage device 2 at the specified destination, and the article is transferred at S1-12. In this event, in the article storage device 2, the label on the delivered article is read by the image sensor 222 to confirm details on a trade at S2-11. Upon confirmation of authorized trade, the article storage device 2 unlocks the door 201 and permits the article to be stored at S2-12. Then, as the article has been stored, the door 201 is locked at S2-13. Then, the article storage device 2 transmits an electronic mail to the user terminal 3 at S2-6 notifying that the ordered article has been stored. As the user receives the article at S2-7, the storage environment control for the article container 22 is terminated.

In this way, the electronic shop 1 converts detailed trade information on an article ordered by the user into a two-dimensional code, prints the code on a label which is adhered on an article box. The article storage device 2 reads the label by the image sensor 222 to confirm the details on the trade, and unlocks the door 201 of the article container 22 if an authorized trade is confirmed, so that the authorized article can be securely stored in the article storage device 2 without fail.

While in the foregoing embodiment, the detailed trade information is transmitted from the electronic shop 1 to the article storage device 2, the present invention is not necessarily limited to this transmission of the detailed trade information. Alternatively, the user terminal 3 may receive the detailed trade information from the electronic shop 1 and transfer it to the article storage device 2.

(Fourth Embodiment)

A fourth embodiment is also identical to the aforementioned first embodiment in the general configuration. The fourth embodiment employs an alternative article storage device 2 which reads a two-dimensional code on a label by the image sensor 222 to confirm an authorized article before the container environment control is started.

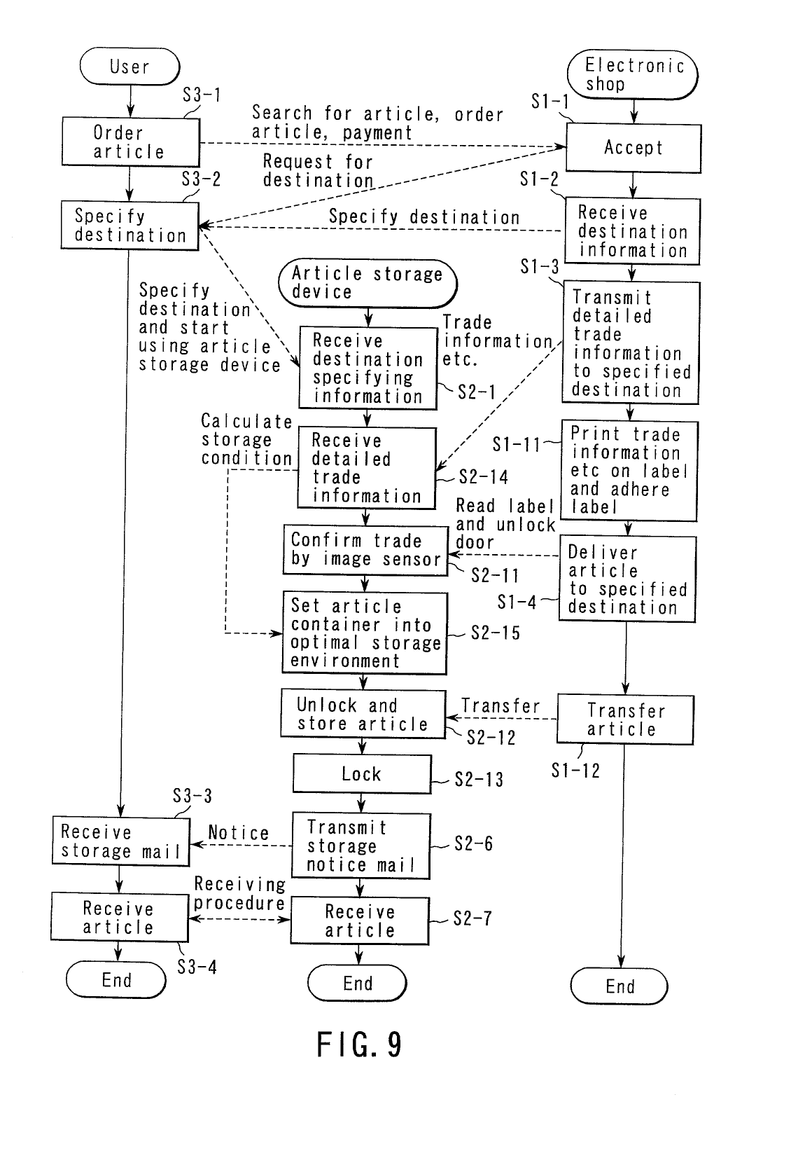

FIG. 9 is a flow diagram illustrating communications among the electronic shop 1, article storage device 2, and user terminal 3. The communications are made through the network communication line 4. It should be noted that steps identical to those in FIGS. 7 and 8 are designated the same reference numerals, and detailed description thereon is omitted.

As the electronic shop 1 transmits necessary information such as article information, storage condition and the like to the article storage device 2 at a specified destination as detailed trade information at S1-3, the article storage device 2 receives the detailed trade information from the electronic shop 1, and calculates a storage condition at S2-14. Then, the article storage device 2 reads a label on a delivered article by the image sensor 222 to confirm the details on a trade at S2-11. Upon confirmation of an authorized trade, the article storage device 2 controls the environment sensor unit 203 and container environment control unit 204 to optimize an environment condition, including at least temperature or humidity, within the article container 22 based on the calculated storage condition at S2-15. Then, the article storage device 2 unlocks the door 201 and permits the article to be stored at S2-12. Then, as the article has been stored, the door 201 is locked at S2-13. Then, the article storage device 2 transmits an electronic mail to the user terminal 3 at S2-6 notifying that the ordered article has been stored. As the user receives the article at S2-7, the storage environment control for the article container 22 is terminated.

In this way, the electronic shop 1 converts detailed trade information on an article ordered by the user into a two-dimensional code, prints the code on a label which is adhered on an article box. The article storage device 2 reads the label by the image sensor 222 to confirm the details on the trade, and unlocks the door 201 of the article container 22 if an authorized trade is confirmed, so that the authorized article can be securely stored in the article storage device 2 without fail. Moreover, since the image sensor 222 reads the label to confirm an authorized article before the container environment control is started, the electric power can be further saved.

While in the foregoing embodiment, the detailed trade information is transmitted from the electronic shop 1 to the article storage device 2, the present invention is not necessarily limited to this transmission of the detailed trade information. Alternatively, the user terminal 3 may receive the detailed trade information from the electronic shop 1 and transfer it to the article storage device 2.

(Fifth Embodiment)

A fifth embodiment is also identical to the aforementioned first embodiment in the general configuration. The fifth embodiment employs an alternative article storage device 2 which records its availability as a log record together with the article information, storage condition, and the like.

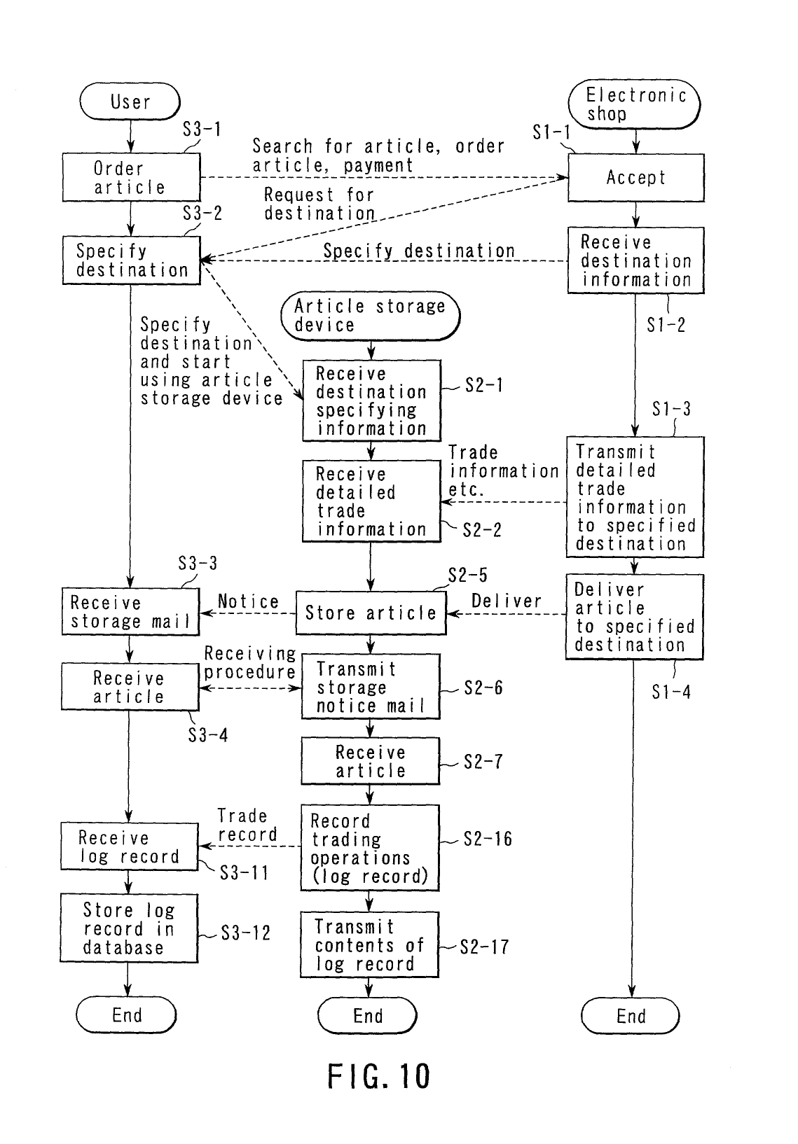

FIG. 10 is a flow diagram illustrating communications among the electronic shop 1, article storage device 2 and user terminal 3. The communications are made through the network communication line 4. It should be noted that steps identical to those in FIGS. 7 through 9 are designated the same reference numerals, and detailed description thereon is omitted.

Upon confirming receipt of an article at S2-7, the article storage device 2 terminates the storage environment control for the article container 22, and records associated trading operations at S2-16. In other words, a log record is created and stored. This means that the availability of the article storage device 2 is created as a log record together with article information, storage condition and the like for storage. Then, at S2-17, the article storage device 2 transmits the created log record to the user terminal 3. Upon receipt of the log record from the article storage device 2 at S3-11, the user terminal 3 stores the log record for making a database at S3-12.

In this way, the article storage device 2 creates the availability as a log record together with the article information, storage condition and the like, and stores the created log record, while the user terminal 3 receives the log record from the article storage device 2 for making a database, thereby allowing the user to precisely keep track of an operating situation for the article storage device 2.

While in the foregoing embodiment, the created log record is transmitted to the user terminal 3 each time it is created, the present invention is not necessarily limited to this way of transmission. Alternatively, the log record may be transmitted on a periodic basis, or may be transmitted in response to a request from the user. Also, the entire log record may be transmitted, or only a portion subsequent to the previously transmitted log record may be transmitted.

In the foregoing embodiment, the detailed trade information is transmitted from the electronic shop 1 to the article storage device 2, the present invention is not necessarily limited to this transmission of the detailed trade information. Alternatively, the user terminal 3 may receive the detailed trade information from the electronic shop 1 and transfer it to the article storage device 2.

(Sixth Embodiment)

A sixth embodiment is also identical to the aforementioned first embodiment in the general configuration. The sixth embodiment employs an alternative article storage device 2 which transmits a storage notice mail to the user terminal 3, and receives a confirmation notice from the user terminal 3.

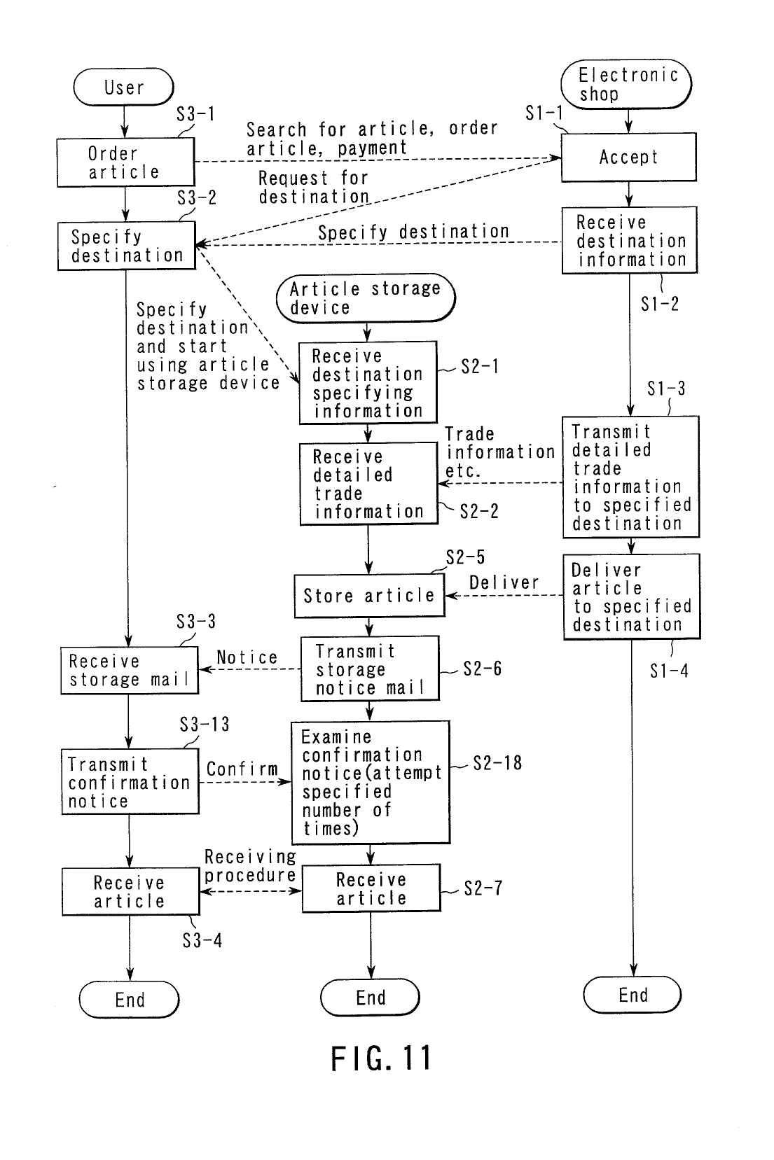

FIG. 11 is a flow diagram illustrating communications among the electronic shop 1, article storage device 2 and user terminal 3. The communications are made through the network communication line 4. It should be noted that steps identical to those in FIGS. 7 through 10 are designated the same reference numerals, and detailed description thereon is omitted.

As the article storage device 2 permits a delivered article to be stored in the article container 2 and confirms the storage at S2-5, the article storage device 2 transmits an electronic mail for notifying the user terminal 3 of the storage at S2-6. This notice includes information on the stored article, stored date and time, storage condition, and the like. Then, at S2-18, the article storage device 2 examines a confirmation notice. Upon confirmation of the storage notice mail at S3-3, the user terminal 3 transmits a confirmation notice to the article storage device 2 at S3-13. Then, the user goes to the article storage device 2 for receiving the article at S3-4. At the article storage device 2, the user receives the article at S2-7. Then, as the article is received by the user, the storage environment control for the article container 22 is terminated.

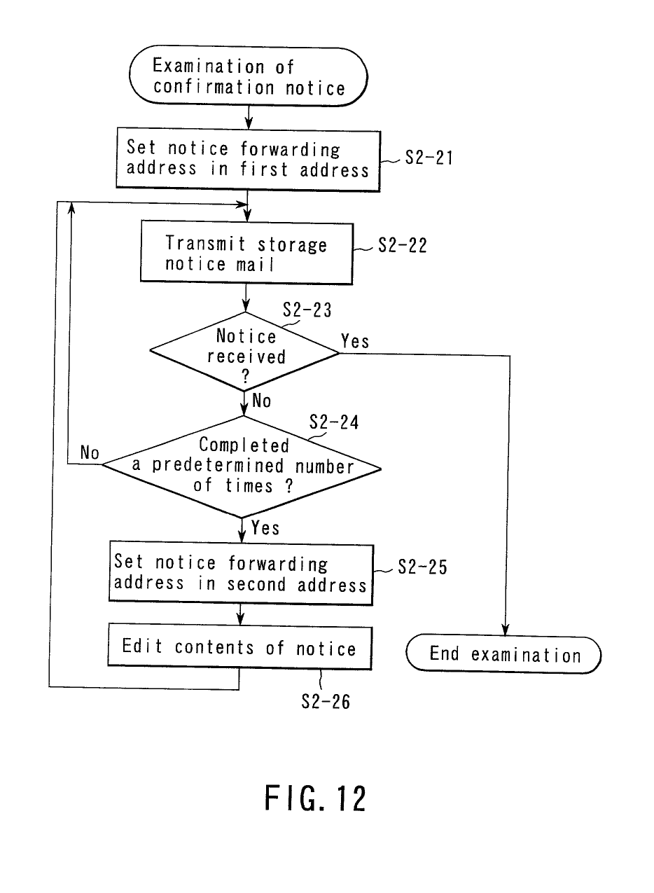

In the confirmation notice examination at S2-18 by the article storage device 2, as illustrated in FIG. 12, the article storage device 2 first sets the address of the user terminal 3 in a first address as the notice forwarding address at S2-21, and transmits a storage notice mail to the notice forwarding address at S2-22. Then, the article storage device 2 determines at S2-23 whether a confirmation notice has been received from the user terminal 3. If received, the examination is terminated. Otherwise, the article storage device 2 determines at S2-24 whether the storage notice mail has been transmitted a predetermined number of times, and again transmits the storage notice mail to the notice forwarding address at S2-22 if the specified number of times has not been reached.

When the specified number of times has reached, the article storage device 2 sets a second notice forwarding address specified by the user in a second address at S2-25, newly re-edits the contents of the notice at S2-26, and transmits the new storage notice mail to the second notice forwarding address at S2-22.

In this way, as an article is stored in the article storage device 2, the article storage device 2 transmits a storage notice mail to the user terminal 3. Upon confirmation of the storage notice mail, the user terminal 3 transmits a confirmation notice to the article storage device 2 which terminates the examination for the confirmation notice upon determining the receipt of the confirmation notice, or periodically repeats the transmission of the storage notice mail until the predetermined specified number of times is reached if no confirmation notice has been received from the user terminal 3, and transmits the storage notice mail to a second notice forwarding address specified by the user after the specified number of times has been reached. Therefore, even if the article is stored in the article storage device 2 for a long term because the user is late in coming to receive the article, the user can be notified without fail. Also, when the user has not yet come to receive the article even after the storage notice mail was transmitted to the user terminal a specified number of times, the storage notice mail is transmitted to the second notice forwarding address specified by the user, so that the user can be notified more securely that the ordered article has been stored.

While in the foregoing embodiment, the detailed trade information is transmitted from the electronic shop 1 to the article storage device 2, the present invention is not necessarily limited to this transmission of the detailed trade information. Alternatively, the user terminal 3 may receive the detailed trade information from the electronic shop 1 and transfer it to the article storage device 2.

(Seventh Embodiment)

A seventh embodiment is also identical to the aforementioned first embodiment in the general configuration. The seventh embodiment employs an alternative article storage device 2 which reads a two-dimensional code from a label by the image sensor 222, and images and records a person in charge of delivery of an article.

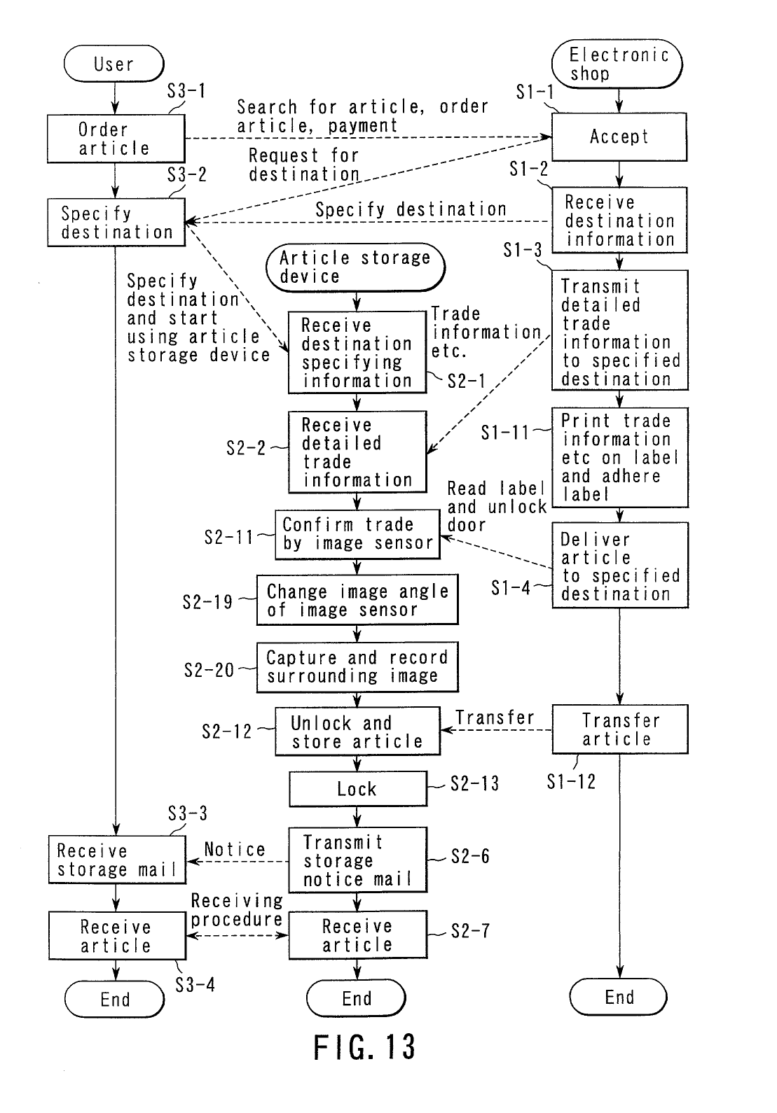

FIG. 13 is a flow diagram illustrating communications among the electronic shop 1, article storage device 2 and user terminal 3. The communications are made through the network communication line 4. It should be noted that steps identical to those in FIGS. 7 through 12 are designated the same reference numerals, and detailed description thereon is omitted.

The electronic shop 1 transmits necessary information such as article information, storage condition and the like to the article storage device 2 at a specified destination as detailed trade information at S1-3, converts the detailed trade information into a two-dimensional code which is printed on a label which is then attached on an article box at S1-11, and delivers the article to the article storage device 2 at the specified destination at S1-4. The article storage device 2 receives the detailed trade information from the electronic shop at S2-2, reads the label on the delivered article by the image sensor 222 to confirm details on a trade at S2-11. Subsequently, at S2-19, the article storage device 2 controls an image angle adjuster unit 202 to change the image angle of the image sensor 222 such that the image sensor 222 can image how a person in charge of delivery delivers the article.

Then, at S2-20, the article storage device 2 captures the image read by the image sensor 222 for storage. Subsequently, if the delivered article is an authorized one, the article storage device 2 unlocks the door 201 to permit the person in charge to place the storage into the article container 22 at S2-12. As the article has been stored, the article storage device 2 locks the door 201 at S2-13. Then, the article storage device 2 transmits an electronic mail to the user terminal 3 at S2-6 notifying that the ordered article has been stored. As the user receives the article at S2-7, the storage environment control for the article container 22 is terminated.

In this way, the article storage device 2 changes the image angle of the image sensor 222 to image and capture how the person in charge of delivery delivers the article, and stores the captured image, so that the user can know the situation when the person in charge of delivery delivered the article. Thus, if the user is troubled with the delivered article, the user can confirm the person in charge of the delivery of the article, so that the user can relatively smoothly solve the problem.

While in the foregoing embodiment, the image angle adjuster unit 202 changes the image angle after the image sensor 222 has read the label to confirm the details on the trade, the present invention is not necessarily limited to this procedure. Alternatively, the image angle may be changed after the person in charge enters the field of view of the image sensor 222.

While in the foregoing embodiment, the detailed trade information is transmitted from the electronic shop 1 to the article storage device 2, the present invention is not necessarily limited to this transmission of the detailed trade information. Alternatively, the user terminal 3 may receive the detailed trade information from the electronic shop 1 and transfer it to the article storage device 2.

(Eighth Embodiment)

An eighth embodiment is also identical to the aforementioned first embodiment in the general configuration. The eighth embodiment employs an alternative article storage device 2 which creates a unique article code that is notified to the user terminal 3, and requests the user to enter the unique article code when the user attempts to unlock the door 201.

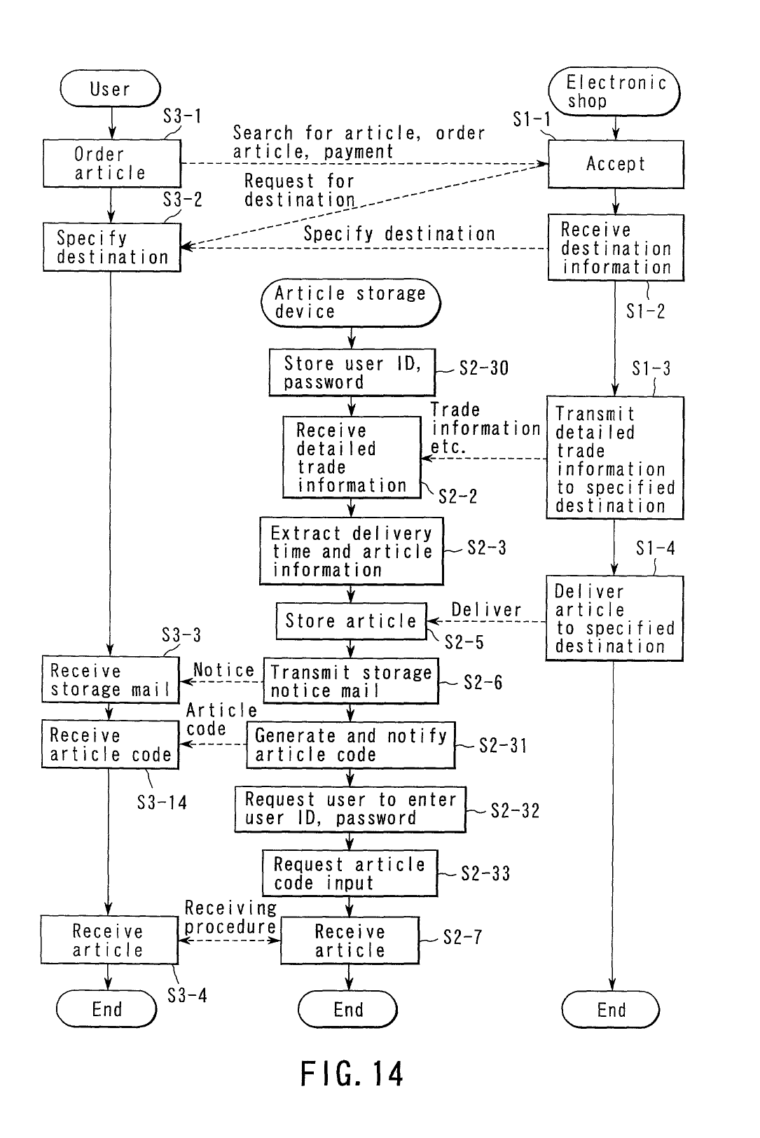

FIG. 14 is a flow diagram illustrating communications among the electronic shop 1, article storage device 2 and user terminal 3. The communications are made through the network communication line 4. It should be noted that steps identical to those in FIGS. 7 through 13 are designated the same reference numerals, and detailed description thereon is omitted.

First, at S2-30, the article storage device 2 stores a user ID and a password entered from the instruction input unit 206. This is previously done. In this state, as the article storage device 2 receives detailed trade information from the electronic shop 1 at S2-2, the article storage device 2 extracts a delivery time and article information from the detailed trade information at S2-3. When an article is delivered from the electronic shop 1, the article storage device 2 permits the article to be stored in the article container 22 and confirms the storage at S2-5, and transmits a storage notice mail to the user terminal 3 at S2-6. The user terminal 3 receives a unique article code from the article storage device 2 at S3-14.

Subsequently, at S2-31, the article storage device 2 creates an article code, which is unique code information, making use of the preset user ID and password and the article information from the electronic shop 1. This article code is changed each time the article storage device 2 is utilized. Then, the article storage device 2 transmits the created unique article code to the user terminal 3.

Upon unlocking the door 201 of the article container 22, the article storage device 2 requests the user to enter the user ID and password at S2-32. When the user enters the preset user ID and password, the article storage device 2 again requests the user to enter the unique article code informed to the user terminal 3 at S2-33. When the user enters the correct article code, the article storage device 2 unlocks the door 201 and permits the user to retrieve the article.

In this way, the user ID and password have been previously registered in the article storage device 2. When the article storage device 2 receives detailed trade information on an ordered article from the electronic shop 1, and the delivered article is later stored in the article container 22, the article storage device 2 creates a unique article code making use of the user ID and password as well as article information from the electronic shop 1, and informs the created article code to the user terminal 3. Upon unlocking the door 201 of the article container 22, the article storage device 2 requests the user to enter the user ID, password, and unique article code, and unlocks the door 201 only when they are correctly entered, thereby making it possible to ensure that the article is delivered only to the user who has ordered the article. In other words, even if the user ID and password are exposed, the user must further enter the article code known only to the user, so that the privacy of the user can be more securely protected.

While in the foregoing embodiment, the delivery time and article information are extracted from the detailed trade information received from the electronic shop 1 through the network communication line 4, the present invention is not necessarily limited to this manner of extracting such information. Alternatively, an article may be accompanied by a label on which a delivery time and article information are printed, such that the label is read by the image sensor.

While in the foregoing embodiment, the detailed trade information is transmitted from the electronic shop 1 to the article storage device 2, the present invention is not necessarily limited to this transmission of the detailed trade information. Alternatively, the user terminal 3 may receive the detailed trade information from the electronic shop 1 and transfer it to the article storage device 2.

(Ninth Embodiment)

A ninth embodiment is also identical to the aforementioned first embodiment in the general configuration. The ninth embodiment employs an alternative article storage device 2 which can notify parties associated with a trade that an article has been received.

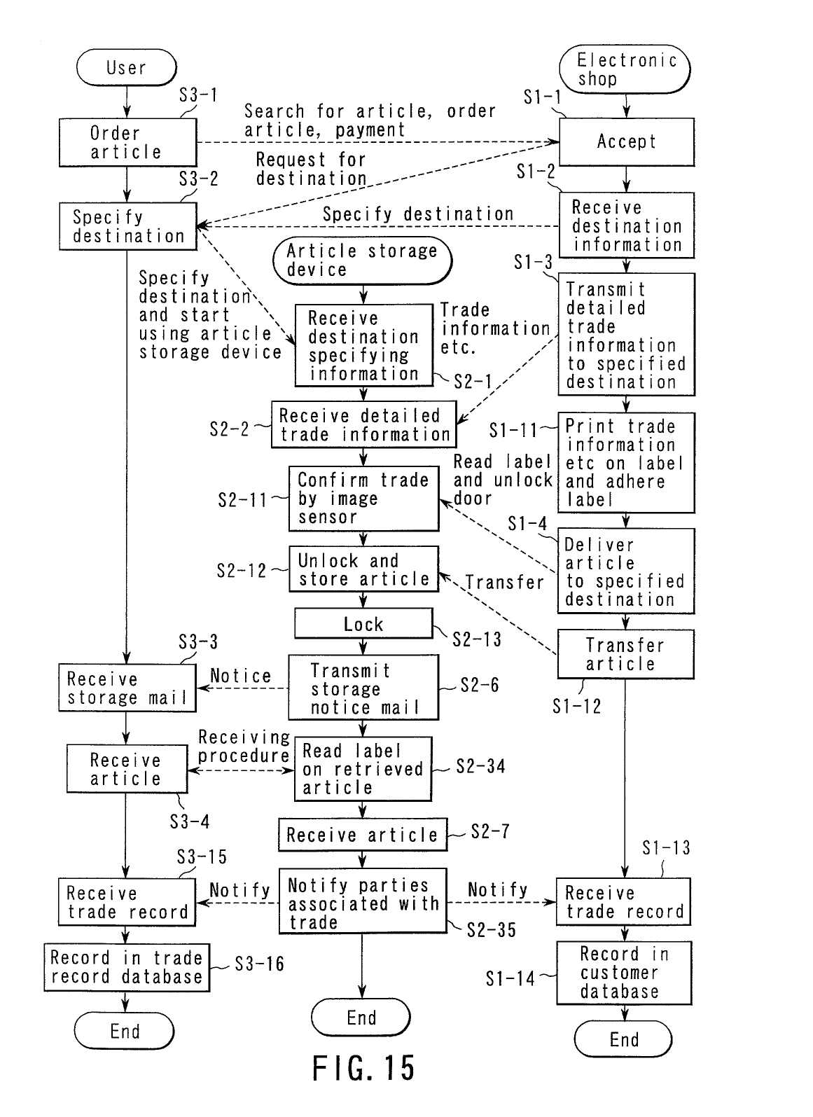

FIG. 15 is a flow diagram illustrating communications among the electronic shop 1, article storage device 2 and user terminal 3. The communications are made through the network communication line 4. It should be noted that steps identical to those in FIGS. 7 through 14 are designated the same reference numerals, and detailed description thereon is omitted.

As the article storage device 2 permits the user to receive an article at S2-7, and the user receives the article, the article storage device 2 notifies at S2-35 the electronic shop 1 and user terminal 3, which are parties associated with this trade, that the article has been received. Upon receipt of the article reception notice from the article storage device 2 at S1-13, the electronic shop 1 records in the customer database 15 that the article has been received at S1-14. The user terminal 3 in turn, upon receipt of the article reception notice from the article storage device 2 at S3-15, records in a trade record database that the article has been received at S3-16.

In this way, when an article is received at the article storage device 2, the article storage device 2 notifies the electronic shop 1 and user terminal 3 to that effect. The electronic shop 1 records the notice in the customer database 15, while the user terminal 3 records it in the trade record database, so that the electronic shop 1, which is the sender, can confirm at all times that the article has been received, and the user terminal 3 can leave the reception of the article as a record.

While in the foregoing embodiment, the detailed trade information is transmitted from the electronic shop 1 to the article storage device 2, the present invention is not necessarily limited to this transmission of the detailed trade information. Alternatively, the user terminal 3 may receive the detailed trade information from the electronic shop 1 and transfer it to the article storage device 2.

(Tenth Embodiment)

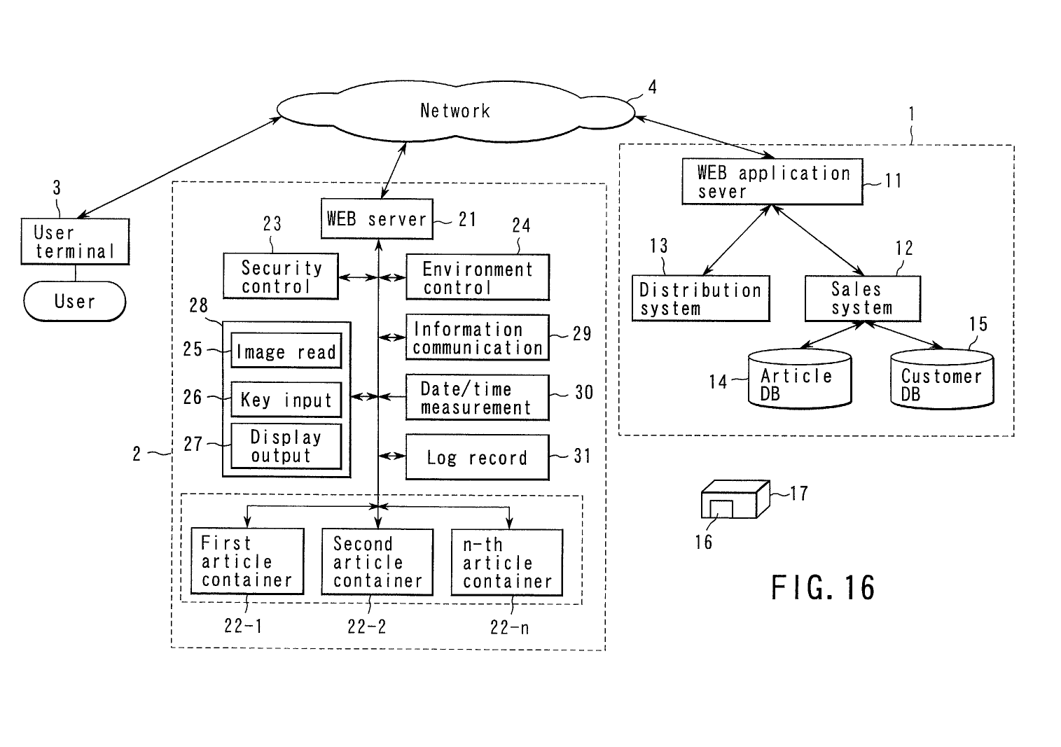

As illustrated in FIG. 16, a tenth embodiment employs an alternative article storage device 2 which comprises n article containers 22-1, 22-2, . . ., 22-n which are different in storage volume from one another. The remaining configuration is identical to the aforementioned first embodiment.

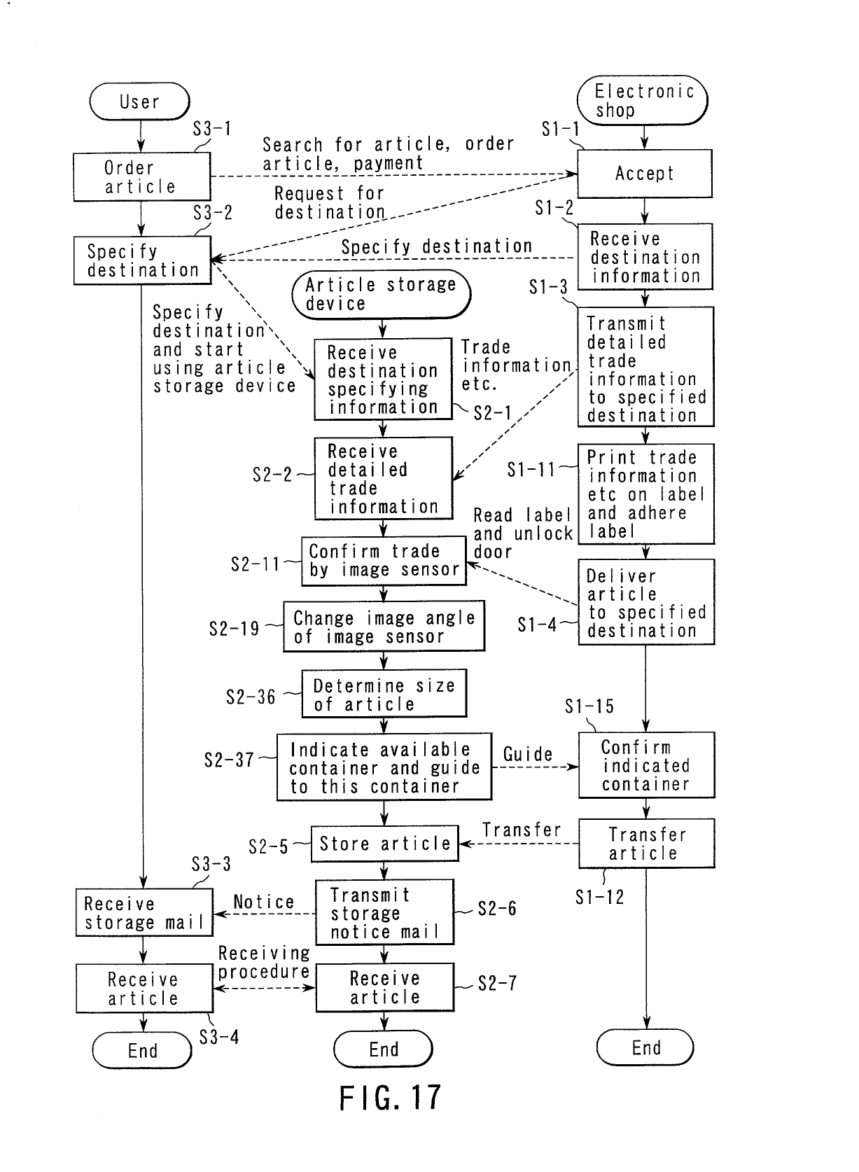

FIG. 17 is a flow diagram illustrating communications among the electronic shop 1, article storage device 2 and user terminal 3. The communications are made through the network communication line 4. It should be noted that steps identical to those in FIGS. 7 through 15 are designated the same reference numerals, and detailed description thereon is omitted.

At S2-11, the article storage device 2 reads a label 16 attached on an article by the image sensor 222 to confirm details on a trade, and subsequently controls the image angle adjuster unit 202 to change the image angle of the image sensor 222 at S2-19 so that the image sensor 222 can image the entire article to determine the size of the article. Then, the article storage device 2 determines the size of the article at S2-36.

At S2-37, the article storage device determines from the result of determination which article container can accommodate the article, and guides a person in charge of delivery to that article container, using a display on the display unit, a speech or the like. The person in charge of delivery on the electronic shop side confirms how he is guided at S1-15.

Subsequently, the article storage device 2 unlocks the door 201 at S2-5, and permits the person in charge to place the article in the selected article container. Thus, the person in charge opens the door 201 of the specified article container to store the article at S1-12.

In this way, the article storage device 2 comprises n article containers different in storage volume from one another, images an entire article by the image sensor 222 to determine the size thereof, selects an article container which can accommodate the article, and notifies the person in charge of delivery of the selected article container, so that the article storage device 2 can support articles of various sizes.

While in the foregoing embodiment, the detailed trade information is transmitted from the electronic shop 1 to the article storage device 2, the present invention is not necessarily limited to this transmission of the detailed trade information. Alternatively, the user terminal 3 may receive the detailed trade information from the electronic shop 1 and transfer it to the article storage device 2.

(Eleventh Embodiment)

An eleventh embodiment is also identical to the foregoing tenth embodiment in the general configuration. However, in the eleventh embodiment, n article containers 22-1, 22-2, . . . , 22-n need not be different in storage volume from one another, but may be identical.

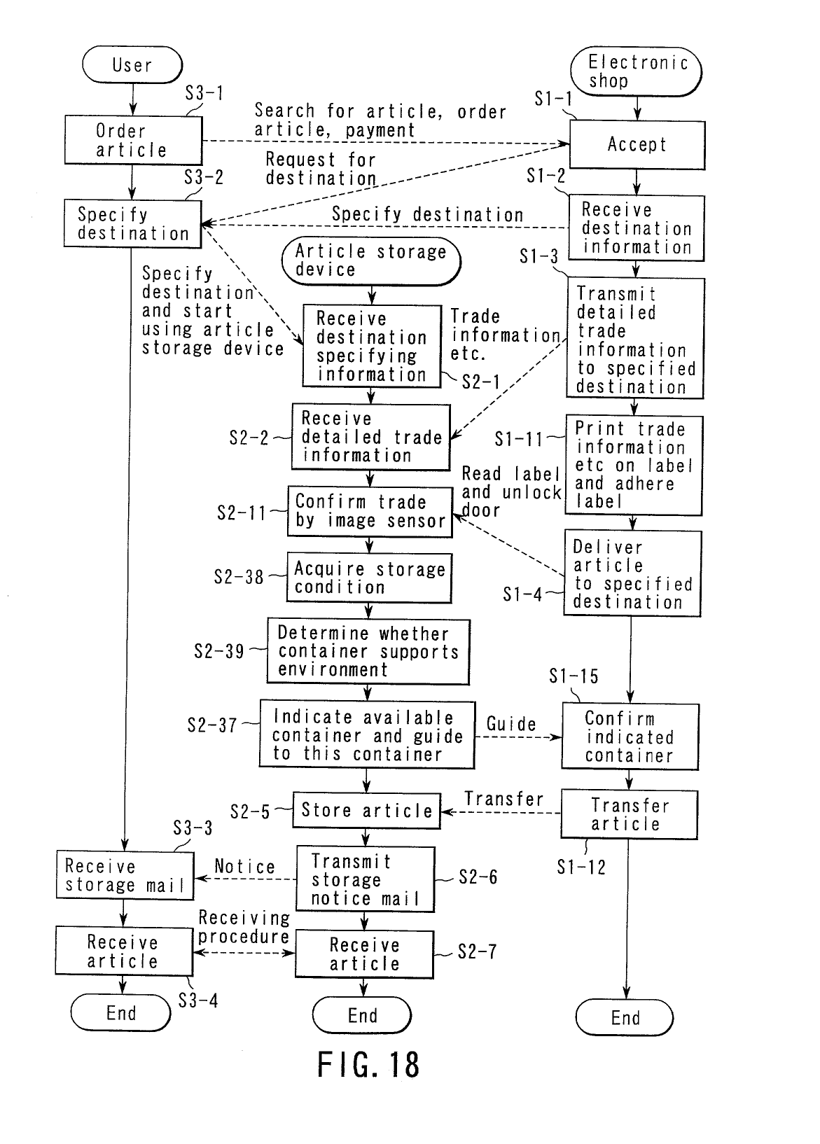

FIG. 18 is a flow diagram illustrating communications among the electronic shop 1, article storage device 2 and user terminal 3. The communications are made through the network communication line 4. It should be noted that steps identical to those in FIG. 17 are designated the same reference numerals, and detailed description thereon is omitted.

The article storage device 2 reads a label 16 adhered on an article by the image sensor 222 to confirm details on the trade at S2-11, and then acquires a storage condition for the article at S2-38. Then, the article storage device 2 determines at S2-39 which of the article containers supports an environment for the article. For example, the article storage device 2 has an article container which has stored an article in a predetermined storage condition suitable for the article, and determines whether or not a storage condition for the presently delivered article is compatible with this article container.

Then, the article storage device 2 determines at S2-37 which of the article containers can accommodate the article, and guides a person in charge of delivery to that article container using a display on the display unit, a speech or the like. In this event, if the storage condition for the presently delivered article is compatible with the storage condition in the article container which has previously stored an article, the article storage device 2 specifies this article container, or specifies another empty article container if not compatible, and controls the article container for the storage environment such that the specified article container is compatible with the storage condition for the presently delivered article.

In this way, the article storage device 2 comprises n article containers to select another article container for an article which requires a different storage condition, informs a person in charge of delivery of the selected article container, and controls the selected article container for the storage environment such that the article container is compatible with the storage condition for the presently delivered article, so that a plurality of articles requiring different storage conditions could be stored in the article storage device 2 without fail.

While in the foregoing embodiment, the detailed trade information is transmitted from the electronic shop 1 to the article storage device 2, the present invention is not necessarily limited to this transmission of the detailed trade information. Alternatively, the user terminal 3 may receive the detailed trade information from the electronic shop 1 and transfer it to the article storage device 2.

(Twelfth Embodiment)

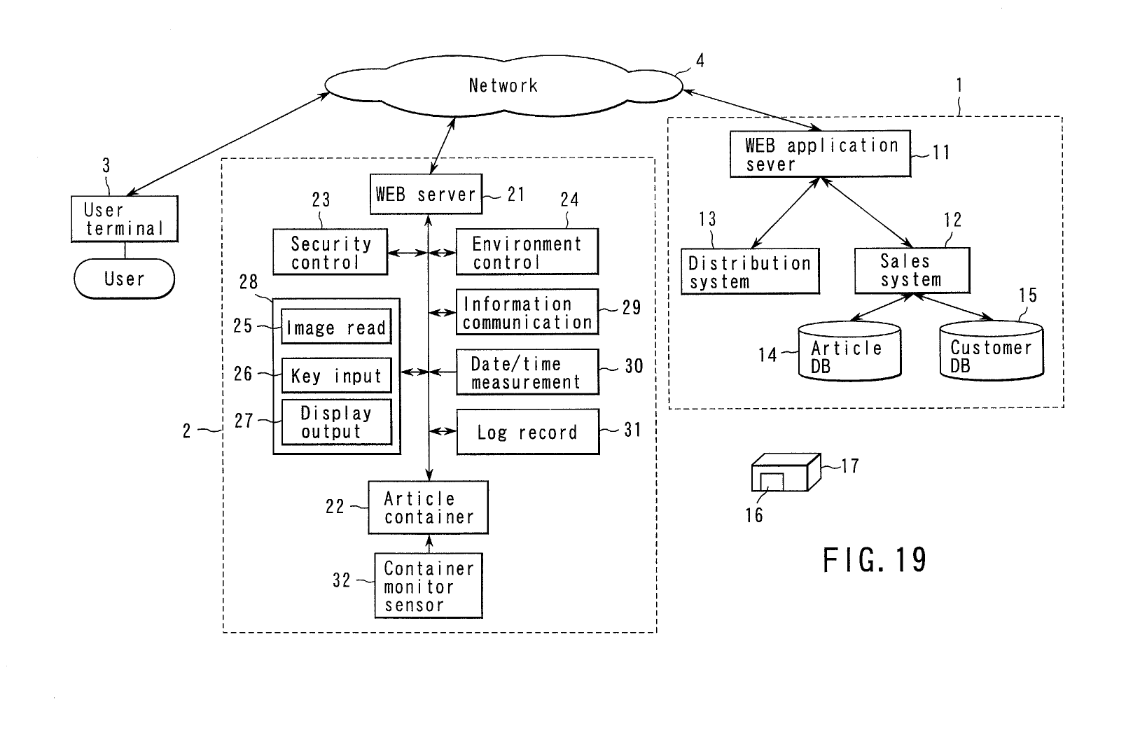

As illustrated in FIG. 19, a twelfth embodiment employs an alternative article storage device 2 which comprises a container monitor sensor 32 for monitoring the inside of the article container 22. The container monitor sensor 32 is capable of monitoring the article container 22 in color. The remaining configuration is identical to the aforementioned first embodiment.

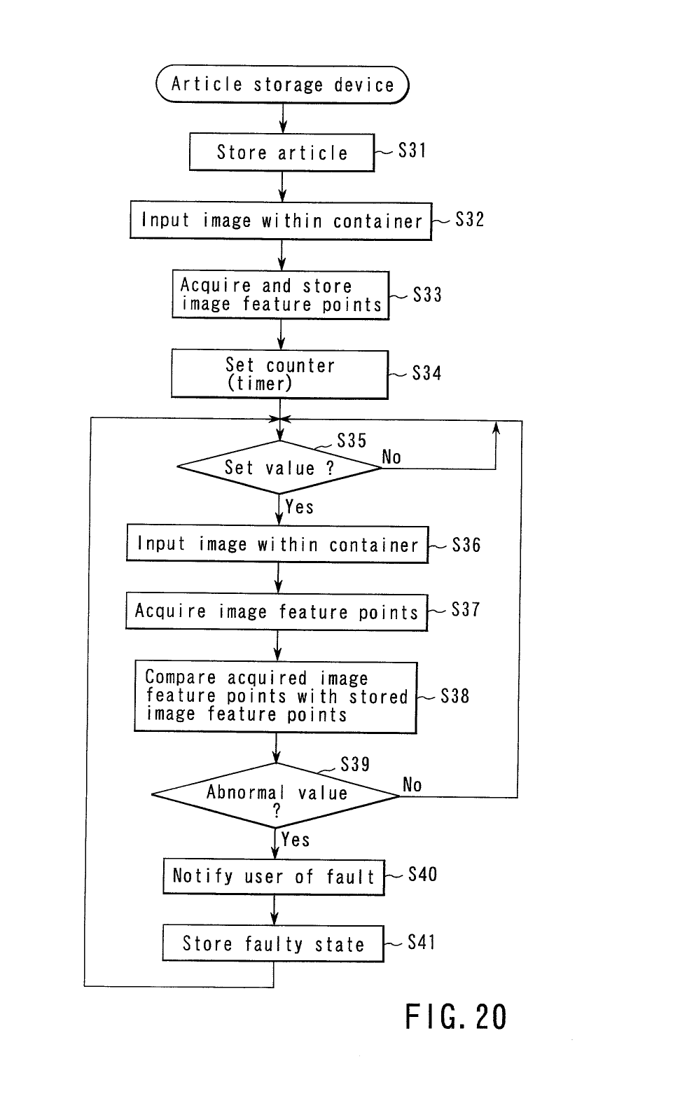

FIG. 20 is a flow diagram illustrating the operation of the article storage device 2. As a delivered article is stored in the article container 22 at S31, the container monitor sensor 32 images the inside of the article container 22 and inputs the image at S32. Then, at step S33, the article storage device 2 extracts image feature points from the input image and stores them as security information. At S34, the article storage device 2 sets a counter for measuring a time. The image feature points may be the quantity, hue, or color density of stored articles, the coordinates of the center of gravity of each article, and the like.

Then, the article storage device 2 determines at S35 whether a predetermined time has elapsed. As the counter has counted a set value, indicating that the predetermined time has elapsed, the inside of the article container 22 is again imaged by the container monitor sensor 32 to input the image at S36. The article storage device 2 extracts image feature points from the input image at S37, and numerically compares the currently extracted image feature points with the image feature points which have been extracted and stored the previous time at S38. Specifically, the article storage device 2 compares the quantity, hue, or color density of stored articles, the coordinates of the center of gravity of each article, and the like.

No problem arises if the image feature points of both images are coincident. However, if they are not coincident, and an abnormal value is detected at S39, the article storage device 2 notifies the user terminal 3 of a fault at S40, and records the faulty state at S41.

In this way, the inside of the article container 22 is imaged by the container monitor sensor 32 to detect at regular time intervals for comparison how many articles are stored, articles of which hue or which color density are stored, how the stored articles are shaped, and which coordinates of the center of gravity each of them has. If a fault is detected, the user can be notified of the fault, so that if some of articles, for example, is missing, the user can be immediately notified to that effect.

(Thirteenth Embodiment)

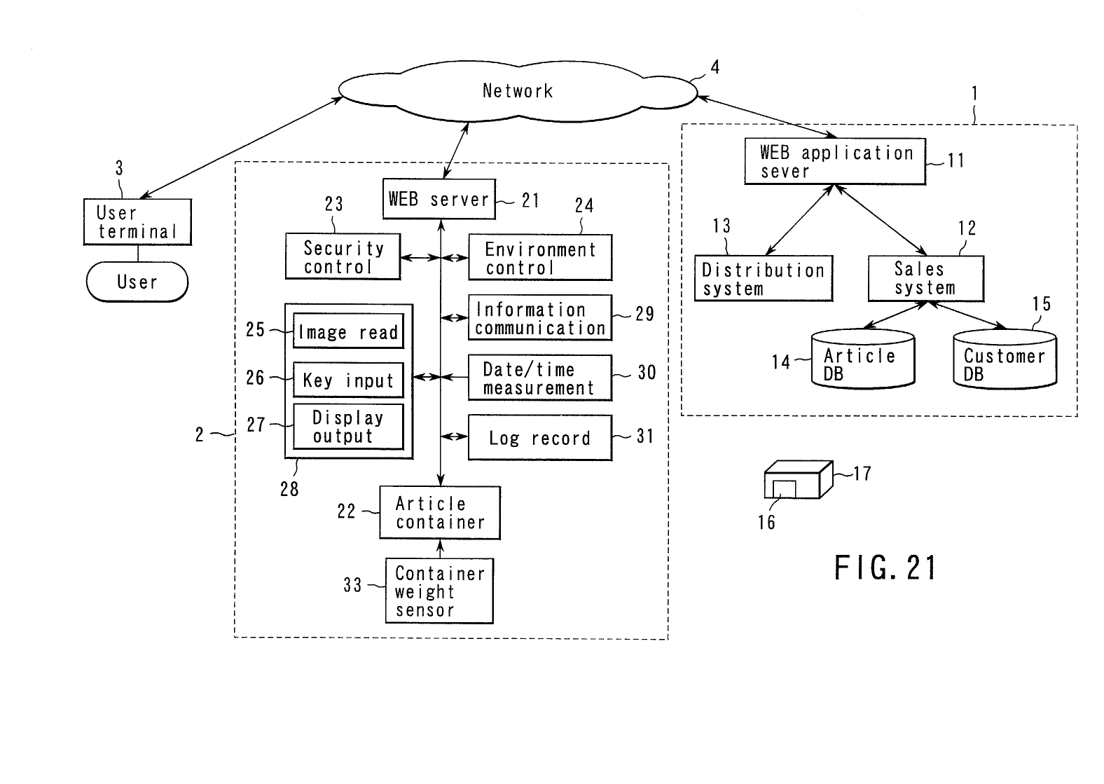

As illustrated in FIG. 21, a thirteenth embodiment employs an alternative article storage device 2 which comprises a container weight sensor 33 within the article container 22. The remaining configuration is identical to the aforementioned first embodiment.

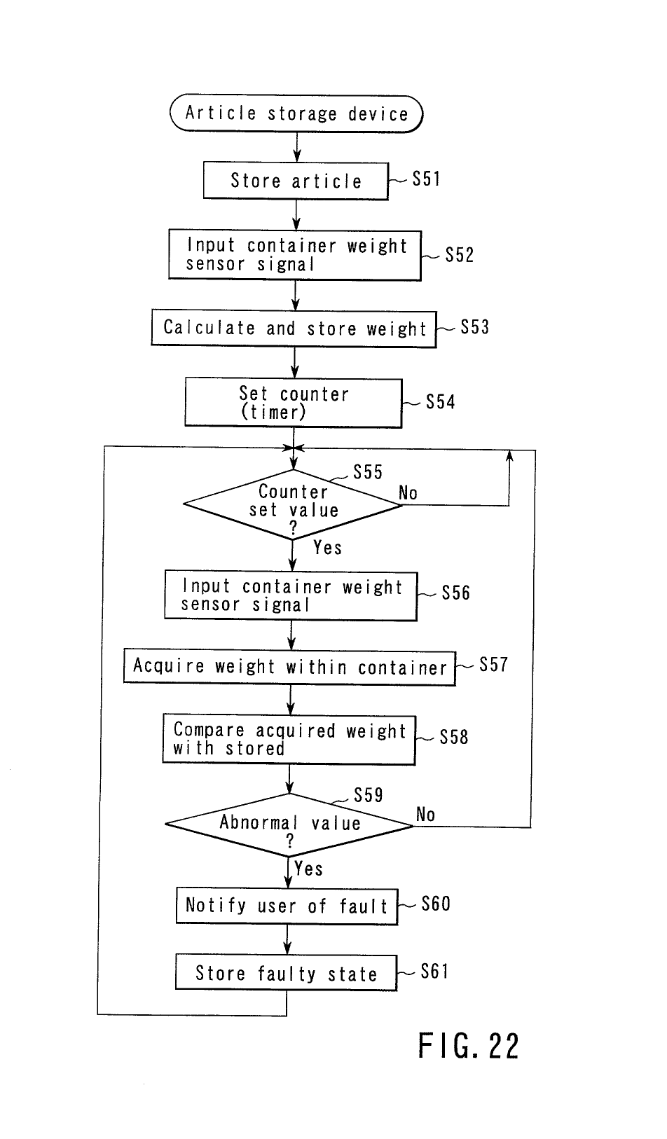

FIG. 22 is a flow diagram illustrating the operation of the article storage device 2. As a delivered article is stored in the article container 22 at S51, the article storage device 2 receives a signal from the container weight sensor 33 within the article container 22 at S52. Then, the article storage device 2 calculates a weight value from the input signal, and stores the calculated value at S53, and sets a counter for measuring a time at S54.

Then, the article storage device 2 determines at S55 whether a predetermined time has elapsed. As the counter has counted a set value, indicating that the predetermined time has elapsed, the article storage device 2 again receives a signal from the container weight sensor 33 within the article container 22 at S56. Then, at S57, the article storage device 2 calculates a weight value from the input signal, and compares the currently calculated weight value with the previously calculated and stored weight value at S58. No problem arises if both weight values are coincident, However, if they are different, and an abnormal value is detected at S59, the article storage device 2 notifies the user terminal 3 of a fault at S60, and records the faulty state at S61.

In this way, the container weight sensor 33 is provided within the article container 22 to detect the weight of an article stored in the article container 22 at regular time intervals and compare the current and previous weight values. If a fault is detected, the user can be notified of the fault, so that if some of articles, for example, is missing, the user can be immediately notified to that effect.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic shop sales system comprising:
an electronic shop connected to a network communication line;
a user terminal connected to said network communication line; and
an article storage device connected to said network communication line, wherein:
said electronic shop comprises:
an article database configured to manage article information and storage conditions;
a sales system configured to present articles managed by said article database to said user terminal through said network communication line for accepting an order of an article sold by said electronic shop from a user; and
a distribution system configured to perform a transaction required to deliver an article accepted through said sales system based on destination information, and
said article storage device comprises:
an article container having a door which is locked and unlocked; and
environment control section configured to control a storage environment in said article container,
and wherein:
said electronic shop sales system is configured to be responsive to an order of an article received from said user terminal, for reading a storage condition for said article from said article database, operating said environment control section of said article storage device based on the storage condition to adjust the storage environment in said article container, storing the ordered article in said article container, and subsequently delivering the article to the user.

2. The electronic shop sales system according to claim 1, wherein:
said distribution system is configured to attach a label on the ordered article, said label having at least the storage condition read from said article database printed thereon, and
said article storage device further comprises:
an input unit configured to input the label data; and
means for reading the storage condition from the label data input through said input unit to operate said environment control section to adjust the storage environment in said article container.

3. The electronic shop sales system according to claim 1, wherein:
said sales system is configured to transmit a storage condition read from said article database to said article storage device through said network communication line, and
said article storage device operates said environment control section based on the received storage condition for the article to adjust the storage environment for said article container.

4. The electronic shop sales system according to claim 1, wherein:
at least one of said electronic shop and said article storage device is configured to notify said user terminal of delivery through said network communication line.

5. The electronic shop sales system according to claim 1, wherein:
said sales system is configured to transmit delivery information to said article storage device through said network communication line for informing a delivery schedule together with a storage condition for an article before the article is stored in said article container of said article storage device, and
said article storage device is configured to previously operate said environment control section based on the received delivery information and storage condition for the article to properly adjust the storage environment in said article container upon storing the article.

6. The electronic shop sales system according to claim 1, wherein:
said distribution system is configured to be responsive to an order of an article from said user terminal for reading article information and storage condition for the article from said article database, converting the read article information and storage condition for the article into a machine code, printing the machine code on a label, and attaching the label on the article, and
said article storage device further comprises:
a reader configured to read the machine code from said label;
a receiver configured to receive the article information and storage condition from said sales system through said network communication line;
means operable when said reader reads the machine code from said label for collating article information and storage condition extracted from the read machine code with the article information and storage condition received from said sales system through said network communication line and automatically unlocking said door when a match is determined; and
means for operating said environment control section of said article storage device based on the storage condition printed on said label read by said reader to adjust the storage environment in said article container.

7. The electronic shop sales system according to claim 6, wherein:
said article storage device further comprises means for automatically locking said door upon confirmation of storage of the article in said article container after said door of said article container was unlocked.

8. The electronic shop sales system according to claim 1, wherein:
said article storage device further comprises:
a storage unit configured to create and store information on articles stored in and removed from said article container, storage/removal schedules, storage conditions as operation records; and
means for notifying the operation records stored in said storage unit to a terminal specified by the user through an electronic mail.

9. The electronic shop sales system according to claim 1, wherein:
said article storage device further comprises:
a storage unit configured to create and store information on articles stored in and removed from said article container, storage/removal schedules, storage conditions as operation records;
means responsive to storage of an article in said article container for notifying a created operation record including information on the article, storage a schedule, storage condition to a terminal specified by the user through an electronic mail, and for periodically repeating the notification if no reception confirmation response is returned from said terminal; and
means for notifying, when the article has been left stored in said article container even though an article storage time limit approaches, another contact address previously specified by the user that the article has been left stored.

10. The electronic shop sales system according to claim 1, wherein:
said distribution system is configured to attach a label on an ordered article, said label having at least article information and storage condition read from said article database printed thereon, and
said article storage device further comprises:
an image sensor; and
an adjuster unit configured to switch an image reading angle of said image sensor, and wherein:
said article storage device is configured to read the article information and storage condition printed on said label by said image sensor and operate said environment control section in accordance with the read storage condition to adjust the storage environment in said article container, and said article storage device is further configured to switch the image reading angle of said image sensor to read a situation image including a person in charge of delivery of the article for recording information on the situation image.

11. The electronic shop sales system according to claim 1, wherein:
said article storage device further comprises:
a storage unit configured to store IDs and passwords previously assigned to users;
means for generating unique code information to a user when an article is stored in said article container and said door is locked;
means for notifying a terminal possessed by the user of the stored unique code information through an electronic mail;
an input unit configured to fetch an ID, password and code information from the outside; and
means for unlocking said door of said article container by reading the ID, password and code information from the outside through said input unit.

12. An electronic shop sales system comprising:
an electronic ship connected to a network communication line;
a user terminal connected to said network communication line; and
an article storage device connected to said network communication line, wherein:
said electronic shop comprises:
an article database configured to manage article information including names, article codes and prices of a variety of articles, storage conditions therefor;
a customer database configured to manage names of customers, detailed trade information;
a sales system configured to present articles managed by said article database to said user terminal through said network communication line for accepting an order of an article sold by said electronic shop from a user; and
a distribution system configured to perform a transaction required to deliver an article accepted through said sales system based on destination information, and wherein:
said distribution system is configured to be responsive to an order of an article from said user terminal for reading article information on the article from said article database and reading the detailed trade information associated with the customer, printing the read article information and trade information on a label, and attaching said label on the article, and
said article storage device comprises:
an article storage device;
environment control section configured to control a storage environment in said article container,
an image sensor configured to read the label attached on the article;
means operable when said image sensor reads the label attached on the article upon retrieval of the article from said article container for inquiring said electronic shop based on the read detailed trade information to acquire information on parties associated with a trade, said parties including a sender of the article, and a person in charge of delivery; and
means for notifying an article reception confirmation to terminals of the parties associated with the trade acquired by said means through an electronic mail, and wherein:
said electronic shop sales system is configured to be responsive to an order of an article received from said user terminal, for reading a storage condition for the article from said article database, operating said environment control section of said article storage device based on the storage condition to adjust the storage environment in said article container, storing the ordered article in said article container, and subsequently delivering the article to the user.

13. The electronic shop sales system according to claim 1, wherein:
said article container of said article storage device includes a plurality of article containers having different storage volumes, and
said article storage device further comprises:
an image sensor;
an adjuster unit configured to switch an image reading angle of said image sensor;
means for switching the image reading angle of said image sensor by said adjuster unit to estimate the size of an overall article;
means for selecting an article container capable of storing the article based on the estimation; and
means for guiding a person in charge of delivery of the article to the selected article container.

14. The electronic shop sales system according to claim 1, wherein:
said article storage device includes a plurality of article containers, said environment control section being configured to control a storage environment in each of said article containers, and
said article storage device further comprises:
means for comparing an adjusted storage environment with a storage environment required for a new article when the new article is to be stored in a predetermined article container which has previously stored an article in the adjusted storage environment;
means for selecting another article container for storing the new article when the comparison indicates that the storage environment required for the new article is different from the adjusted storage environment; and
means for guiding a person in charge of delivery of the article to the selected article container.

15. The electronic shop sales system according to claim 1, wherein:
said article storage device further comprises:
an image sensor configured to image an article stored in said article container;
means for detecting the quantity, hue or color density of stored articles, coordinates of centers of gravity of the articles, from image information captured by said image sensor to store the same as security information;
recording means;
notifying means; and
means for periodically imaging articles by said image sensors to detect the presence or absence of a fault by comparing stored information, recording a fault by said recording means if the fault is determined, and notifying a recorded result by said notifying means through an electronic mail.

16. The electronic shop sales system according to claim 1, wherein:
said article storage device further comprises:
a container weight sensor configured to detect the weight of an article stored in said article container;
means for storing weight information detected by said container weight sensor as security information;
recording means;
notifying means; and
means for periodically detecting the weight by said container weight sensor to detect the presence or absence of a fault by comparing the stored weight information, recording a fault by said recording means if the fault is determined, and notifying a recorded result by said notifying means through an electronic mail.

17. An electronic shop sales method, wherein an article storage device and an electronic shop are interconnected through a network communication line, for selling an article to a user terminal connected to said network communication line from said electronic shop, wherein:
said electronic shop comprises an article database configured to manage article information including names, article codes and prices of a variety of articles, storage conditions therefor for presenting articles managed by said article database to said user terminal through said network communication line, accepting an order of an article sold thereby from a user, and performing a transaction required for delivery based on destination information when an article is accepted,
said article storage device comprises an article container, and environment control section configured to control a storage environment in said article container,
said method comprising:
receiving an order of an article from said user terminal;
reading a storage condition for said article from said article database;
operating said environment control section of said article storage device based on the storage condition to adjust the storage environment in said article container;
storing the ordered article in said article container; and
delivering the article to the user by way of said article storage device.
